(19) United States
(12) Patent Application Publication
(10) Pub. No.: US 2014/0213330 A1
(43) Pub. Date: Jul. 31, 2014

(54) Cell Phone / Phone Case Finger Clutches

(71) Applicant: Seung Woon Oh, Leesburg, VA (US)

(72) Inventor: Seung Woon Oh, Leesburg, VA (US)

(21) Appl. No.: 13/751,081

(22) Filed: Jan. 26, 2013

(51) Int. Cl. H04B 1/38

(52) U.S. Cl. CPC H04B 1/3888
USPC 455/575.6

(57) ABSTRACT

The cell phone finger clutch allow user to hold their phone using the finger clutch, having cell phone resides on the palm of the user's hand without effort to gripping the phone. It eases the accessibility of the phone by user's finger. The finger clutch helps user to secure their phones.

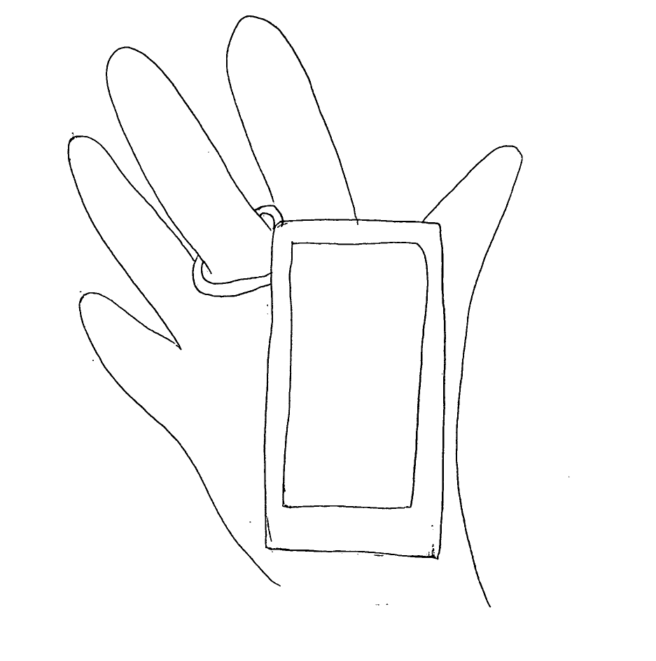

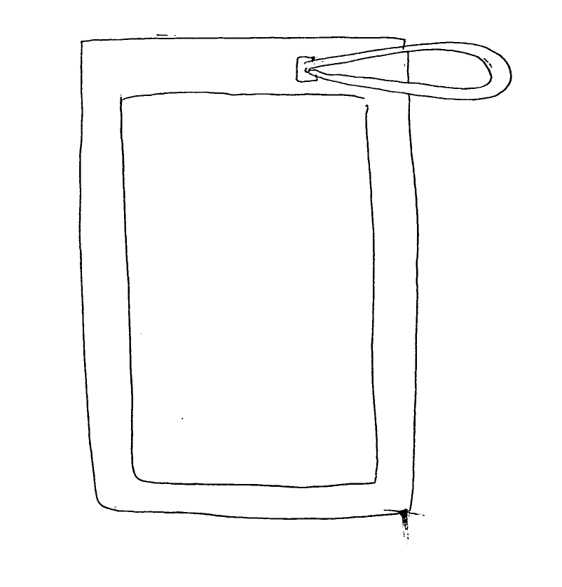

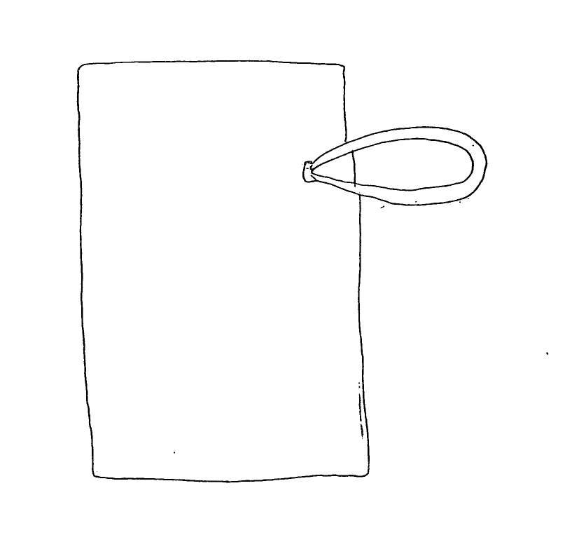

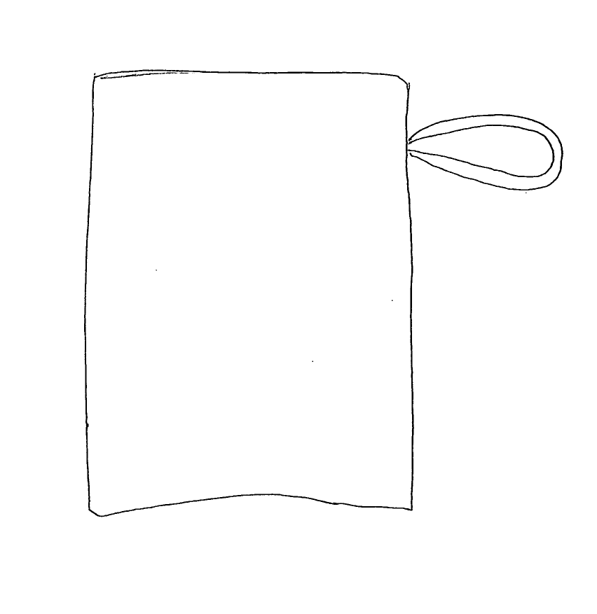

### CROSS-REFERENCE TO RELATED APPLICATIONS

N/A

### BACKGROUND OF THE INVENTION

Almost all adults, teens and even young children carry their cell phones. Many people carry their phone with their hand and it can be tiring to firmly hold their phone in their hand for a long period of time. The finger clutches allows user to hold their phone without effort to gripping the phone and therefore it relieve the tension in their hands. It allows easy access to the phone using just their fingers. It also secures the phone.

### BRIEF SUMMARY OF THE INVENTION

The cell phone finger clutches allows user to hold on to the cell phone using the finger clutches without grabbing the phone in their hands. It allows user to use touch screen with a single finger with the support of the clutches. It secures the cell phone in their hands. Unlike wrist clutches, this product allows the cell phone to be inside their hand, making the phone easily accessible without using entire hand.

### BRIEF DESCRIPTION OF THE FIGURES

1—Front side view that shows the phone/phone case with finger clutches. This shows the finger clutch is used with the middle finger. It can be used with the index, thumb, or any finger user chooses to use.

2—Front side view that shows the phone/phone case with finger clutch. This illustrates the phone/phone case with finger clutch attached to the front side of the device

3—Back side view of the phone/phone case with finger clutch. This illustrates the phone/phone case with the finger clutch attached in the back of the device.

4—Back side view of the phone/phone case with finger clutch. This illustrates the back side view of the phone/phone case with finger clutch on the side of the device.

1. The finger clutches can be attached to the cell phone itself
It can be attached to the front of the cell phone
It can be attached to the back of the cell phone
It can be attached to the side of the cell phone
The finger clutches can be attached to the cell phone case
It can be attached to the front of the cell phone case
It can be attached to the back of the cell phone case
It can be attached to the side of the cell phone case
The finger clutches can be used by any finger
The finger clutches material can be of any material including rubber, plastic, metal that are not harmful to the person wearing it
